(19) United States
(12) Patent Application Publication
(10) Pub. No.: US 2010/0242454 A1
(43) Pub. Date: Sep. 30, 2010

(54) NH3-MONITORING OF AN SCR CATALYTIC CONVERTER

(75) Inventor: Bastian Holderbaum, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV Motorentechnik GmbH, Aachen (DE)

(21) Appl. No.: 12/678,772

(22) PCT Filed: Sep. 18, 2007
(86) PCT No.: PCT/EP07/08115

§ 371 Date: May 19, 2010

(51) Int. Cl. F01N 11/00; F01N 3/10; G01M 15/04

(52) U.S. Cl. 60/301; 73/114.75

(57) ABSTRACT

The present invention relates to an internal combustion engine (1) with an SCR catalytic converter (11) and with a condition monitor (10) of the NH3 level of the SCR catalytic converter, wherein the condition monitor is connected to a first (14) and a second detecting module (15), each of which determines the NH3 level in a different way. In addition, a method for the determination of the NH3 level of an SCR catalytic converter is claimed.

### CROSS-REFERENCE TO RELATED APPLICATIONS

This application is the U.S. national phase of PCT/EP2007/008115 filed Sep. 18, 2007.

### FIELD OF THE INVENTION

The present invention relates to an internal combustion engine with at least one SCR catalytic converter and a condition motoring of the SCR catalytic converter.

### BACKGROUND OF THE INVENTION

It is known from the prior art that an SCR catalytic converter is assessed with respect to its functioning. In DE 43 15 278 A1, the monitoring of NH3 storage is discussed in general terms, but there is no concrete information as to how an NH3 level can be determined. It is described in DE 199 31 007 A1 that during the storage of ammonia, certain physical properties of the SCR catalytic converter change, which can be detected metrologically. The applicant's unpublished WO 2007/096064 describes a regulation and a change from a lean to a stoichiometric operation of a four-stroke engine. In the diesel engine, on the other hand, there is no shift to stoichiometric operation, so the regulation of the engine operation must be done in a different manner if the exhaust gas temperature rises sharply. It is known from paragraph 27 of EP 17 12 764 A1 that an NH3 balance is used as a method for determining an NH3 level of the SCR catalytic converter. These methods have the following background:

At a low exhaust gas temperature, SCR catalytic converters have a high ability to store NH3. In addition, the effectiveness of a catalyst increases with the storage level. An excessively high storage level should be avoided, however since a rapid reversal of the storage capability occurs with increasing temperature, therefore excessive NH3 would be emitted to the environment, i.e., an NH3 slip, as it is referred to below, would occur. For this reason, the storage level must be monitored and regulated to a target value.

The problem of the present invention is to enable a reliable and secure operating mode of an internal combustion engine with an SCR catalytic converter in which NH3 slip can be securely avoided.

### SUMMARY OF THE INVENTION

The problem is solved by an internal combustion engine as well as by a method disclosed herein. Advantageous configurations and refinements follow from the respective subordinate claims.

An internal combustion engine is proposed with at least one SCR catalytic converter and with at least one condition monitor (10) for the NH3 level of the SCR catalytic converter, wherein the condition monitor is connected to at least one first and one second detecting module that determine the NH3 level in different ways. Preferably a correlation unit is connected to the first and second detecting modules. A refinement has a stored weighting function by means of which an NH3 slip between different detections of the NH3 level can be at least partially compensated. At least one detecting module preferably comprises a sensor that is capable of recording a value in relation to the NH3 level.

It is preferred that at least the first and/or the second detecting module comprise an integration of a mass flow relative to a supplied and consumed NH3 mass flow and/or have one or more stored characteristic diagrams containing a dependency of an NOx conversion on a stored NH3 amount in the SCR catalytic converter and/or a physical model of the SCR catalytic converter that has kinetic approaches to a storage behavior and/or a characteristic diagram-based determination of a current NH3 level of the SCR catalytic converter.

Another configuration provides that the condition monitor be coupled to a load check and/or an SCR temperature check, wherein an NH3 slip avoidance threshold is present, and if it is exceeded, an operating mode changeover of the internal combustion engine is initiated.

It is additionally preferred that the condition monitoring be coupled to an NH3 level regulation. One or more SCR catalytic converters can be present. They can be connected in parallel and/or in series. One or more metering functions for one or more reducing agents can also be present. Correlation can be performed for each individual SCR catalytic converter and/or for several SCR catalytic converters in common.

According to another conception of the invention, a method for determining an NH3 level of an SCR catalytic converter for an internal combustion engine, preferably an internal combustion engine described above or below, is proposed, in which a value relevant to a respective NH3 level is determined by at least two different determination paths, and they are correlated to deduce a resulting NH3 level. Preferably a respective NH3 level is acquired on the different determination paths, and these are correlated with one another in order to acquire a resulting NH3 level.

A refinement provides that a drift between at least two differently determined values be deduced from the results of the different determination paths.

For example, a diagnostic system can be created with the proposed method that uses the different determination paths to check a subsystem for determining the NH3 level.

Another configuration provides that a threshold value is set for a beginning of an NH3 slip, and if it is exceeded, the internal combustion engine changes its operating mode. The threshold value can be changeable, for example, more particularly, adaptable. For example, the threshold value can be stored in a characteristic diagram or specified by a control device.

It is further proposed that at least one of the proposed determination paths be used for monitoring an SCR catalytic converter of an internal combustion engine. Further characteristics and explanations regarding the proposed internal combustion engine and the method will be described below.

The current NH3 level is determined according to one embodiment in at least two, preferably several ways, independently of one another. The NH3 level of the SCR catalytic converter cannot be directly measured. Therefore methods with which the NH3 level can be determined must be developed or used. If NOx sensors are used for this calculation, then it must be taken into account that these sensors have a certain inaccuracy. Since the storage level is derived from the integral of a difference, e.g., input NH3 amount minus consumed NH3 amount, a considerably incorrect determination of the storage level results over time from even small sensor errors of a few ppm. Another advantage is therefore to achieve a partial compensation or correction of the NOx sensor error by using different methods for determining the NH3 level.

Moreover, an intervention in the engine control is possible to avoid NH3 slip in case of rapidly increasing exhaust gas temperature, so that in case of a temperature increase, higher NOx raw emissions result simultaneously, which lead to a faster drawdown of the stored ammonia. For example, a partial compensation of an NOx sensor error as well as a correction of the sensor signal or a metering can result from multiple determinations of the storage level.

A first method contains the integration of the mass flows of the metered NH3 as well as the NH3 consumed for NOx conversion. The stored NH3 amount results from the difference of these two components. In this method, the metered NH3 amount is determined from the characteristic curve of the metering system. The converted amount is calculated via the NOx conversion, for example, by using NOx sensors upstream and downstream of the SCR catalytic converter, or a model for the NOx emissions. These measurement signals or model values are error-prone to a certain extent. Since an integration is involved, the thus-determined value for the NH3 level becomes less accurate over time.

A second method determines the current NH3 level by way of characteristic diagrams that contain the dependence of the NOx conversion on the stored NH3 amount. This dependence is determined for the SCR catalytic converter by prior experiment. The final value of the NH3 level is determined by means of a weighting of the partial results from the methods used. The weighting can be a function of the various input parameters, for example, the catalytic converter temperature or the exhaust gas mass flow. Alternatively, the arithmetic mean can be taken.

The behavior of the first and the second methods will be described in more detail below. The first method takes into account the complete metered mass flow of the reducing agent. The fact that the reducing agent must possibly first be converted to NH3 via intermediate steps such as thermolysis or hydrolysis is ignored. In addition, part of the reducing agent may not be available at the SCR catalytic converter at all, due to unequal distribution or the formation of deposits. For this reason, the NH3 level determined by the first method is fundamentally higher than the actual NH3 level available for NOx conversion. In contrast, the second method directly monitors whether an NH3 level sufficient for the desired NOx conversion is available. If the NOx conversion is lower than desired, then the calculated level will be reduced and more reducing agent will be metered in. However, an exclusive use of the second method has the risk that the NOx conversion calculated by cross-sensitive NOx sensors will continue to decline in case of an NH3 slip, which would result in a further increase of the reducing agent metering and thus a higher and higher NH3 slip. This can be prevented by the simultaneous use of the first method, which includes the absolute metered amount and thus prevents a larger and larger increase of the metered amount.

In principle, the two methods exhibit the opposite behavior in case of an erroneous signal of the NOx sensors. If two NOx sensors are used for the regulation, for example, one sensor upstream and one downstream of the SCR catalytic converter, and if these two sensors have the same error, this will have no effect on the regulation since only difference signals are used. In the case of different sensor errors, on the other hand, an erroneous determination of the NH3 level results, insofar as only one of the above-mentioned methods is used. A combination of the first and the second methods, on the other hand, allows a partial compensation of the sensor error. If, for example, the downstream NOx sensor indicates an excessively high value caused by a sensor drift or an NH3 slip, then an excessively low NOx conversion is calculated. An NH3 level that is higher than the actual level results in the first method due to the integration of the difference between the metered and the converted NH3 amounts. On the other hand, the second method determines a lower level than actually exists. An overall more plausible NH3 level is determined from the averaging of these individual values, so that the regulation remains stable even in case of a sensor error.

An excessively large deviation of the two determined levels can also be used for adapting the NOx sensor or the metering. If such a deviation is recognized over an applicable period of time, then the metering is first reduced in order to check whether there is an NH3 slip. If the deviation is not thereby reduced, then a sensor drift can be deduced and a correction of the sensor signal can be performed. If, on the other hand, an additional ammonia sensor is used downstream of the SCR catalytic converter, then an NH3 slip can be directly measured and the reduction of the metered amount to check for an NH3 slip can be omitted.

Alongside the above-described first and second methods, additional approaches with which the NH3 level can be determined are possible, and their partial results can flow into the weighting for determining the overall NH3 level.

A third method provides a physical model of the SCR catalytic converter that models the storage behavior by means of kinetic approaches, based on material data specific to the catalytic converter, such as cell density, volume, specific surface, coating material, etc. It can also be used for resetting the monitored NH3 storage by setting the NH3 level to zero at a high exhaust gas temperature after the lapse of an applicable time. Such a model can be parameterized by comparison to laboratory studies of an identical SCR catalytic converter.

A fourth method is a characteristic diagram-based determination of the current NH3 level. In this case, the NH3 level is determined as a function of the feed ratio, for example, the metered NH3 concentration/NOx concentration upstream of the SCR catalytic converter, and boundary values determining the NOx conversion, e.g., temperature, spatial velocity, NO2/NOx ratio upstream of the SCR catalytic converter, etc., as well as the time constant for the storage process. Based on these values, the NH3 level can be determined by integration of the metered NH3 and NOx amounts.

In addition, a metrological determination of the NH3 level can be performed by utilizing the fact that physical properties of the SCR catalytic converter change when NH3 is stored. These connections are described in the above-mentioned patent DE 199 31 007 A1, which is incorporated in full by reference in this regard within the scope of the present disclosure. A metrological method for determining the NH3 level, which, in addition to the formation of a partial result, can flow into the determination of the overall level, is already described in DE 199 31 007 A1. The shift from lean to lambda-1 operation is described in WO 2007/096064. But even in a purely lean operation, a sharp increase in the load can lead to a rise of the exhaust gas temperature and thus a reduced NH3 storage capability, so that an intervention in the engine operation is necessary in order to be able to reduce the storage level on time. For the possibility of how the change of operating mode can be performed, WO 2007/096064 is incorporated in full by reference within the scope of the present disclosure. In relation to a possible configuration of a balancing, EP 1 712 764 A1 is incorporated by reference.

For example, a rapid rise of the SCR catalytic converter temperature can occur in case of a sharp increase in the load. This has the effect that, even with metering deactivated, the amount already stored in the SCR catalytic converter can no longer be completely reacted in the form of NOx conversion, but can escape into the environment as NH3 slip. This can be countered by switching the engine into a different operating mode with higher raw NOx emissions and possibly simultaneously lower fuel consumption due, for example, to a reduced exhaust gas return rate or an advanced beginning of injection.

NOx sensors have a maximum possible accuracy that may not be sufficient for exact regulation of the metering, and moreover, they react cross-sensitively to ammonia. Therefore it is currently necessary to use model-based regulation systems that are difficult to supply with data, or the metering regulation is deliberately set up such that the maximum possible NOx efficiency is not used, in favor of avoiding NH3 slip. The advantage of the technical teaching described here is that at least partial compensation of measurement errors becomes possible by using several different methods for determining the amount of NH3 stored in the SCR catalytic converter, wherein the influence of sensor deviations for two methods is opposite, so that a compensation of the error is realized, or recognition of NH3 slip or a sensor error becomes possible. An adaptation of this sensor or the metering is thereby possible.

In case of a sharp temperature rise of the SCR catalytic converter, it is possible, according to another conception of the invention, also independent, to avoid a slip of the ammonia stored at a lower temperature by adjusting the engine operating mode in such a way that the raw NOx emissions are elevated and the increased NH3 conversion necessary for the reduction of these nitrogen oxides lowers the NH3 level sufficiently quickly. Such an engine operating mode can also lead at the same time to a lower fuel consumption.

According to an additional conception of the invention, the NH3 level can also be determined in other ways in addition to the methods described above. If more than two methods are used, the effort to supply data and the complexity of obtaining plausible information also increase. A weighting of the individual components can be introduced for the averaging to determine the overall NH3 level. This can also be designed to be temperature-dependent. For example, the characteristic diagram-based level can be assigned a higher weight in this manner at low temperatures, while the level determined from the balance can be assigned a higher influence at high temperatures.

Various advantages of the invention, each of which can also be individually pursued further as an invention, independently of the others, will be presented below:
stand-alone determination of the current NH3 storage level in several ways with subsequent weighting and formation of an overall value;
use of a characteristic diagram that takes into account the dependence of the NOx conversion on the level;
compensation of measurement errors occurring from sensor errors or NH3 slip by contrary influence of this measurement error on the methods used;
checking of the deviations between the results of the methods employed, and adaptation of the metering in case of recognized NH3 slip or adaptation of the NOx sensor value in case of a recognized sensor error;
inclusion of additional level determination and/or metrological detection of the level;
shift of the engine operating mode to increase the raw NOx emission in case of a rise in the exhaust gas temperature in order to rapidly draw down the stored ammonia to avoid NH3 slip;

A particularly preferred application of the invention, which can also be pursued independently of the others, results as follows, for example:
regulation of the NH3 level, particularly at low exhaust gas temperatures in the motor vehicle, in order to achieve high NOx conversion;
avoidance of a heating strategy of the SCR catalytic converter in case an optimized regulation leads to conformance with the NOx limit values already at low temperature, thereby avoiding extra fuel consumption;
avoidance of an extra NH3 trap catalytic converter downstream of the SCR catalytic converter, for example, if the regulation is limited to an NH3 breakthrough at a minimal level; thereby saving an additional component and thus costs and installation space as well as additional calibration effort, particularly in case of ODB;
change of the engine operating mode toward higher raw NOx emissions with simultaneously reduced fuel consumption.

### BRIEF DESCRIPTION OF THE DRAWINGS

The invention will be described below on the basis of illustration examples. The details and features evident from these illustrations are not to be interpreted as limiting, however. Rather, they are to be understood only as one of several possible implementations or possibilities. Moreover, characteristics evident from the individual figures can be linked with other characteristics from other figures or from the above general description to form additional configurations. In detail:

FIG. 1 shows a schematic representation example of the arrangement of an internal combustion engine, an SCR catalytic converter and additional components;

FIG. 2 shows a representation example of the dependence of an ammonia storage capability versus the temperature of an SCR catalytic converter,

FIG. 3 shows a representation of an NOx conversion rate as well as an ammonia slip relative to an ammonia level of an SCR catalytic converter,

FIG. 4 shows a schematic representation of the determination of an NH3 level in an SCR catalytic converter in various ways and its further processing,

FIG. 5 shows a compensation of at least two different determination paths of an NH3 level for acquiring a level arising therefrom,

FIG. 6 shows a representation example of regulation of an NH3 level by means of a regulator integrated with the monitor, and

FIG. 7 shows a contrast of various operating modes of the internal combustion engine, wherein an NH3 slip appears in the upper area of FIG. 7 if there is no change of the operating mode, and the prevention of an NH3 slip by changing the operating mode is illustrated in the lower area of FIG. 7.

### DETAILED DESCRIPTION OF THE INVENTION

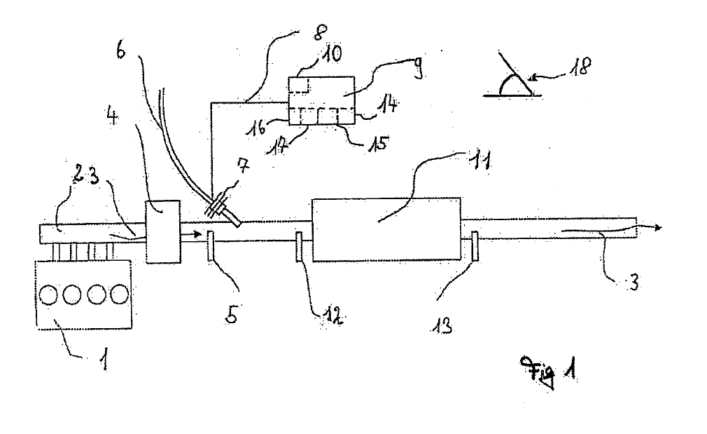

FIG. 1 shows a possibility of arranging various components of the system in a representation example. This arrangement is not to be interpreted as restrictive, however. Rather, various components can also be arranged at different places. An internal combustion engine 1 can be seen in FIG. 1. It is connected to an exhaust gas system 2. A flow direction of an exhaust gas is indicated by the arrows 3. An oxidation catalytic converter 4 is arranged downstream of internal combustion engine 1, for example. In place of the oxidation catalytic converter 4, there could also be an exhaust gas return directly into internal combustion engine 1 and/or an exhaust gas turbine of an exhaust gas turbocharger. A first NOx sensor 5 is arranged downstream of oxidation catalytic converter 4, for example. The former is preferably arranged upstream of an inlet of a reducing agent supply line 6 in exhaust gas system 2. Reducing agent supply line 6 has a valve 7, for example. A metered amount of a reducing agent can be supplied in a controlled manner or regulated in a targeted manner by means of this valve, for example, an injector. Valve 7 is connected for this purpose via a data line 8 to a control device 9, for example, an engine control device. A condition monitor 10 for an SCR catalytic converter 11 is preferably contained in control device 9. Control monitor 10 can also be housed, however, in a separate control or regulation device that is connected to control device 9. For the sake of example, at least one temperature sensor is assigned to SCR catalytic converter 11. The temperature sensor 12 is upstream of SCR catalytic converter 11 according to this configuration. It can also be integrated into the SCR catalytic converter, however, or situated downstream of it. One or more temperature sensors 12 can also be provided at various of these sites, in order to allow temperature monitoring of the exhaust gas stream and/or SCR catalytic converter 11. A second NOx sensor 13 is arranged downstream of SCR catalytic converter 11. The NOx sensors can also be arranged in a different manner, not limited to the arrangement presented here. In addition to condition monitor 10, the control device 9 according to the configuration presented here additionally implements a first detecting module 14, a second detecting module 15, a correlation unit 16 and a weighting function 17. These individual components can preferably be situated in the same control device but can also be present in different units physically separated from one another. Here they are equipped with a suitable signal transmission path such as a bus system. In order to obtain one or more values necessary for the respective calculation method stored in detecting modules 14, 15, they can be connected, for example, to one or more sensors. In particular, the result with respect to an NH3 level acquired from first detecting module 14 and from second detecting module 15 can be correlated via correlation unit 16. For example, it is provided that the acquired results be adapted via a weighting function 17, so that the overall end result is an NH3 level with which a regulation can be operated. A regulation of the NH3 level is preferably performed by means of an added regulator, which is likewise preferably integrated into control device 9. A load monitor 18 is also provided. The load can be monitored, for example, via a pedal position as illustrated. However, the torque or the rotational speed of internal combustion engine 1 can also be monitored for this purpose. In addition to these illustrated components, components such as sensors, monitoring units and/or additional catalytic converters can be provided, however, they are not shown here in detail for reasons of simplification.

With the internal combustion engine 1 presented here, there is the possibility that several, preferably two, different determination paths are used to be able to determine the level value of SCR catalytic converter 11 more accurately. The first two determination paths presented below are particularly suitable, since the errors in the determination of the level compensate one another at least in part if one determines the level from a weighted average, for example.

The first determination path is to prepare an ammonia balance from the amount of supplied ammonia, which is known from the cycle time of the metering valve, and from the difference of the NOx values upstream and downstream of the SCR catalytic converter 11 as measured by two NOx sensors. Instead of the NOx sensor upstream of SCR catalytic converter 11, a characteristic diagram or a model of the NOx emissions of internal combustion engine 1 could alternatively be used. Under the largely satisfied condition that NOx is not stored to a great extent in SCR catalytic converter 11, the amount of consumed ammonia can be determined from the measured NOx difference. The remainder of the ammonia must consequently be stored in SCR catalytic converter 11 or, in the case of a negative balance, has been depleted. The instantaneous level is obtained by integration of the respective stored amounts. This balance does not take into account an ammonia slip, which should of course be avoided with proper handling of the process. In case of a slip, the cross-sensitivity of the downstream NOx sensor to ammonia also comes into play. This sensor upstream of the catalytic converter is not subjected to ammonia, since it is situated upstream of the injection point for ammonia.

The second determination path likewise provides the measurement of the supplied ammonia and the NOx values upstream and downstream of the SCR catalytic converter. The storage level is not determined in this case by integration from the NOx conversion measured as in the first determination path; instead, the level is determined directly as a function of NOx conversion by way of a characteristic diagram “Ammonia level vs. NOx Conversion.” The NOx conversion is a function of the ammonia availability, in addition to the temperature, the NO₂/NOₓ ratio, the exhaust gas mass flow and other boundary conditions, and thus also of the ammonia level. This dependence is used for determining the level. The advantage is that this method does without integration and thus does not become more and more imprecise over time like the first determination path. According to one configuration, this characteristic diagram method also does not take into account an ammonia slip or the cross-sensitivity of the second NOx sensor to ammonia.

The crucial advantage of the combination of the two determination paths is that errors of measurement due both to ammonia slip and sensor errors can be recognized and partially compensated by averaging the acquired level values. In the two determination paths, the effect of ammonia slip and sensor errors enter the determination paths in opposite directions. If, for example, ammonia slip occurs, then the second NOx sensor, which is downstream of the SCR catalytic converter, will always measure an excessively high NOx value due to the cross-sensitivity to ammonia. In the first determination path, an excessively low NOx and ammonia conversion will be determined and therefore the determined ammonia level will be too high. In the second determination path, on the other hand, an excessively low ammonia supply will be diagnosed from the low NOx conversion rate via the characteristic diagram and thus the ammonia level will be too low. A plausible level value for the ammonia can be achieved by appropriately weighted averaging. The analysis is completely analogous for sensor errors, for example. They also behave in opposite ways.

It may additionally be pointed out that each determination path can itself have a correction factor or some other value with which a deviation, a drift and/or some other change, can be compensated. This can also be provided for the determination paths proposed here and their respective linking with one another.

A diagnosis method for a level drift can also be performed by at least two different determination paths. For this purpose, for example, the supply of ammonia is reduced under otherwise fixed operating conditions; if the levels measured by both methods drift closer to one another as a reaction in the direction described, then an ammonia slip should be diagnosed as a cause for the drift, i.e., the level lies at or above the limit for ammonia slip. If the level values drift further apart, then there is too little ammonia in storage, caused, for example, by a sensor error. These errors can then be compensated by correcting the sensor signal or the metering. An analogous determination can also be made with an increased supply of ammonia. This diagnosis can be used for regulation, for a limit value check or as a plausibility criterion. In this way, for example, the state of the regulation or a threshold value can also be monitored, possibly with a subsequent adjustment by adaptation.

For a third determination path, for example, only the input temperatures and the ammonia and NOx quantities are required in addition to already available characteristic parameters of the SCR catalytic converter such as cell density, material properties and so on, since a physical model is capable of calculating the output values, including the storage level, on its own. This method can be used according to an additional conception of the invention as an additional independent method, particularly for checking the plausibility of the combination of the first and second determination paths, as well as being used as an individual measuring method.

A fourth determination path treats the SCR catalytic converter 11 as a first-order regulation timing element with respect to the storage. For this purpose, the time constants or the behavior over time of the ammonia storage is input into a characteristic diagram as a function of the temperature and the level. The ammonia level can thus be determined at any time from the supply of ammonia and NOx, measured according to the third determination path, for example. The timing element represents an integration. Here, for example, the detailed physical model of the third determination path is replaced by a black box with PT1 behavior in the storage process and DT1 behavior in the emptying of the storage level.

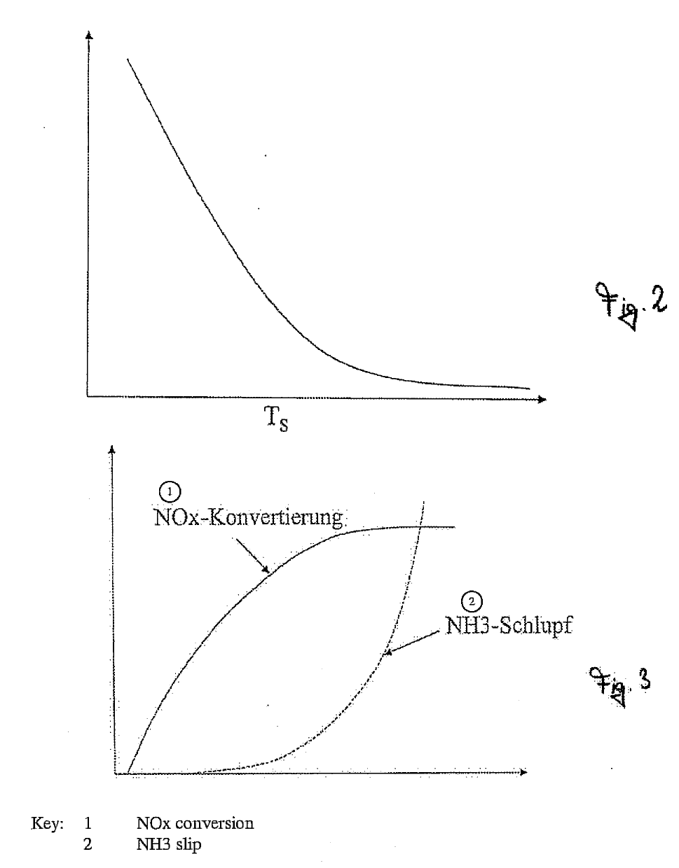

FIG. 2 shows a correlation between an ammonia storage capability, represented on the Y-axis, and a temperature of an SCR catalytic converter, represented on the X-axis. At a low exhaust gas temperature, SCR catalytic converters have a high ability to store NH3 . Moreover, an efficiency of an SCR catalytic converter increases with a storage level. An excessively high storage level should be avoided, however, since a rapid reversal of the storage capability occurs with increasing temperature, as shown, and therefore excessive NH3 would be emitted to the environment. This would result in a so-called NH3 slip. For this reason, the NH3 level of an SCR catalytic converter is monitored and, based on a knowledge of the correlation seen in FIG. 2 specifically for an SCR catalytic converter, a target value is preferably regulated, but is at least initially controlled. In addition, this correlation is used to be able to define one or more different threshold values, for instance, for an NH3 slip.

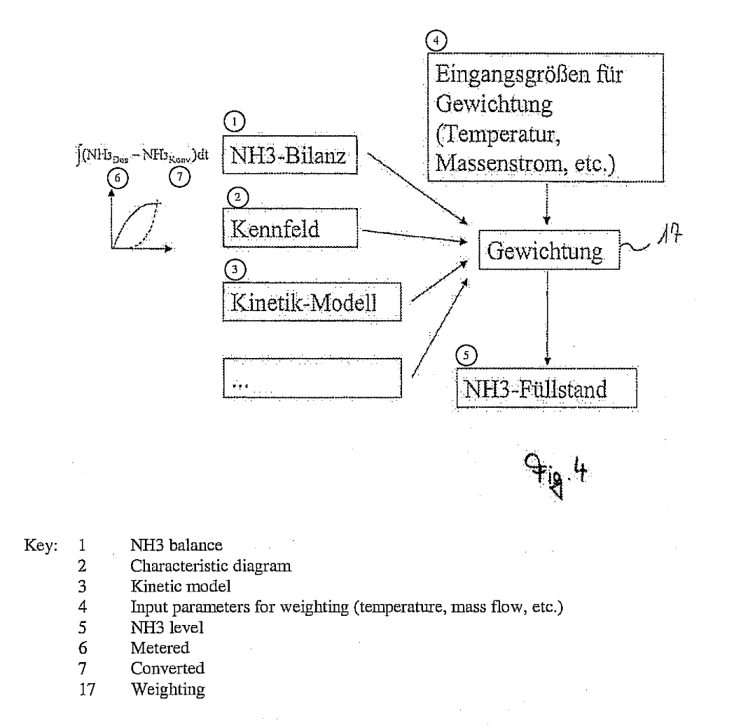

FIG. 3 shows, in a simplified representation, a correlation between an ammonia storage level in an SCR catalytic converter, represented on the Y-axis [sic; X-axis], and an NOx conversion or an NH3 slip, represented on the Y-axis. The higher the NH3 level of the SCR catalytic converter, the greater the possibility that an NH3 slip will occur. The amount that can escape into the environment in case of such an NH3 slip also becomes larger with an increasing NH3 level. Furthermore, since the storage capacity decreases with increasing temperature but NOx emissions also increase with rising temperature, whereas, on the other hand, the efficiency of an SCR catalytic converter in converting NOx increases with increasing NH3 level, it has been found, according to another conception, which can also be further developed, that it is advantageous to provide an intervention in a controller of the internal combustion engine so that higher raw NOx emissions occur in case of a rise in temperature, which lead to a faster drawdown of the stored ammonia.

FIG. 4 shows a configuration of a possible process sequence in an example schematic diagram. Different ways of determining the NH3 level are used here, briefly designated as NH3 balance, characteristic diagram and kinetics model. They can be supplemented by additional types of determination, indicated by the empty box. They are each provided with a weighting factor, indicated by the weighting function 17. A temperature, a water flow or some other parameter can serve as input parameters for a weighting. From the totality, an NH3 level is determined, which is preferably a component of a regulation of the NH3 level of the SCR catalytic converter.

FIG. 5 shows a configuration example of the invention, in which a compensation is used that is based, for instance, on types of NH3 level determination tending to go in different directions. Thus, the determination by way of an NH3 balance tends to move in a different direction than the determination of the NH3 level by a type of characteristic diagram calculation. These two correlated methods at least reduce the otherwise existing deviation error and, in particular, can even cancel one another out with a suitable correlation. In case of excessive deviations, this additionally allows a check of whether one or more of the recorded values is possibly erroneous. In this way, an operational message can be provided as to whether there is an error with, for example, a sensor, a measurement unit, a correlation unit, a detecting module or possibly an SCR catalytic converter. The possibilities for compensation can also be different. This can take place, for example, by weighted averaging. The respectively determined NH3 level values in particular can be at least partially compensated by averaging.

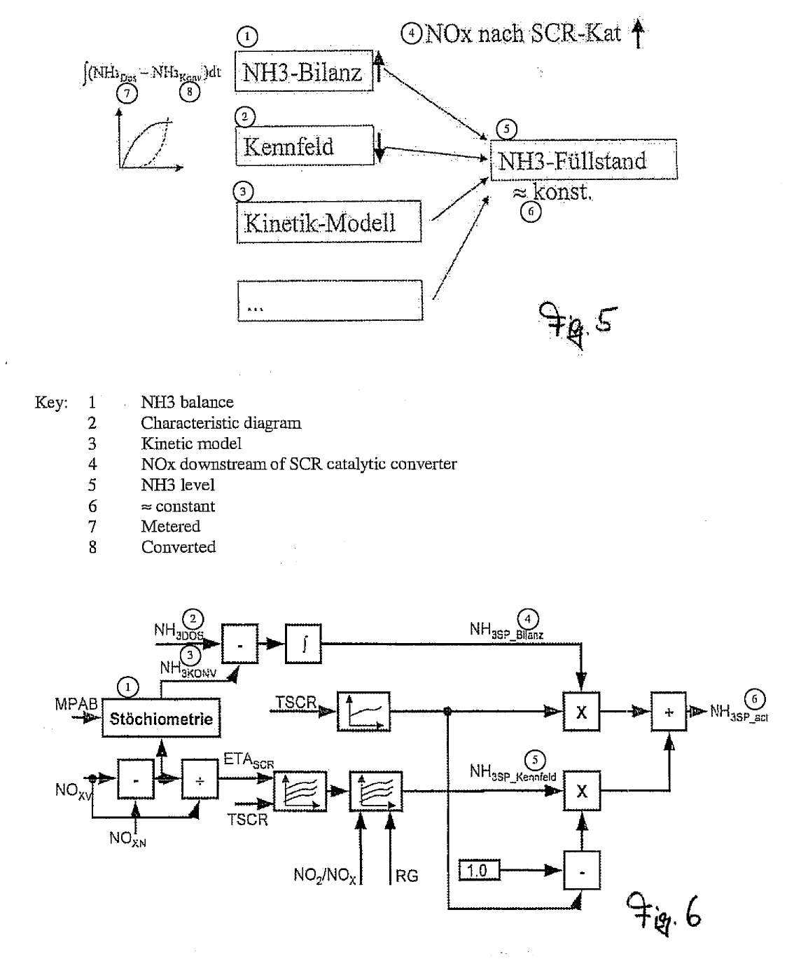

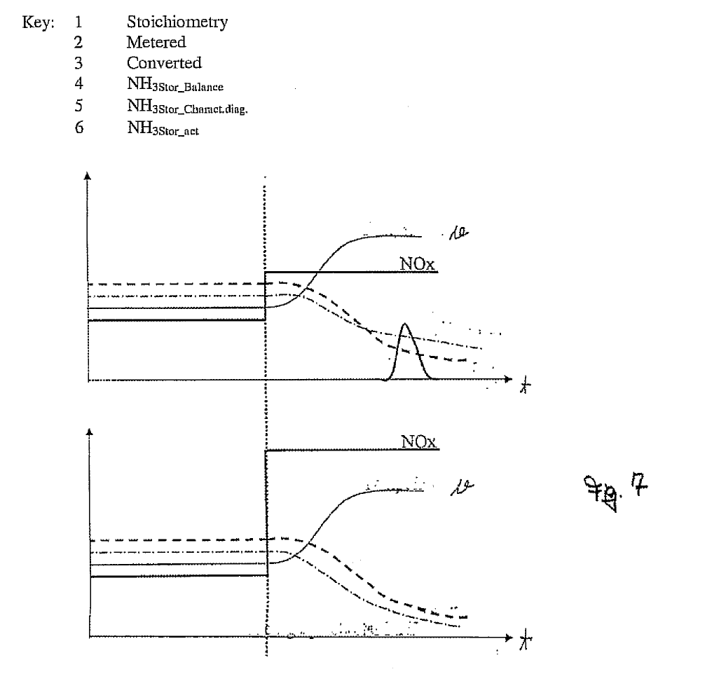

FIG. 6 shows a configuration example of a regulation scheme for determining an NH3 level of an SCR catalytic converter. The NH3 level is indicated as NH_{3Stor}_{_{—}}_{act}. This represents the result of this section of the regulation method. According to this representation, an NH3 level is determined in two ways. First, a first NH3 level is determined via an NH3 balance. This value NH_{3Stor}_{_{—}}_{Balance} enters into the process just like an NH3 level determined by means of a characteristic diagram that takes into account a dependence of an NOx conversion on the NH3 level. This value is specified as a partial result, NH_{3Stor}_{_{—}}_{charact. diag}. With regard to the determination by way of a balancing, for example, an integration of a difference of the metered and converted NH3 mass flow is performed. The determination by means of the characteristic diagram, on the other hand, contains test results for a dependence between the NH3 level and the NOx conversion. An NH3 level can thereby be associated with the measured NOx conversion. This result is corrected by an additional characteristic diagram which takes into account the fact that the NOx conversion is a function of additional boundary conditions such as the NO₂/NOₓ conversion, the NO₂/NOₓ ratio, the spatial velocity, etc., alongside the temperature and the NH3 level. The two partial results are combined, weighted via a temperature-dependent characteristic curve, into the overall result. The values emerging from FIG. 6 are composed as follows:
NH_{3 MET}: metered NH₃ (signal from the metering device)
NH_{3CONV}: converted NH₃
NO_{XV}: NOₓ concentration upstream of SCR catalytic converter (signal from characteristic diagram, calculation or sensor)
NO_{XV}[sic; NO_{XN}]: NOₓ concentration downstream of SCR catalytic converter (NOx sensor)
TSCR: SCR catalytic converter temperature
NH_{3 ST}_{_{—}}_{Balance}: stored NH₃ from balance
NH_{3ST}_{_{—}}_{charact. diag.}: stored NH₃ from characteristic diagram
NH_{3ST}_{_{—}}_{act}: stored NH₃
ETA_{SCR}: efficiency of the SCR catalytic converter
NO₂/NOₓ: ratio of NO₂ to NOₓ concentration upstream of SCR catalytic converter
RG: spatial velocity

FIG. 7 shows in an upper representation that a rapid rise of the SCR catalytic converter temperature can occur in the case of a sharp increase in the load. In comparison to this, an increased load at the same time is indicated by a dotted line in the lower representation. Due to the elevated temperature, a higher formation of NOₓ occurs, and at the same time, there is a decrease of the storage capability of NH₃ in the SCR catalytic converter. This is indicated by the dashed curve, which indicates the maximum NH₃ that can be stored, while the currently stored NH₃ is indicated by the dot-dash line. Due to the increased load and the temperature increase generated thereby, there can be the effect that, even with metering deactivated, the amount already stored in the SCR catalytic converter can no longer be completely reacted in the form of NOₓ conversion. This causes the ammonia to escape into the environment when the currently stored NH₃ value and the maximum storable NH₃ value intersect. This is illustrated by the NH₃ slip that is shown. The operating mode of the internal combustion engine shown thereunder indicates that the temperature of the SCR catalytic conversion also rises in case of an increased load. Therefore the maximum storable NH₃ also declines here. By changing the operating mode of the internal combustion engine, however, a higher NH₃ value can be made available. If in addition to a higher raw NOx emission, a lower fuel consumption is achieved, for example, by means of a reduced exhaust gas return rate or an advanced beginning of injection, the slip formation can be countered. As shown, the currently stored NH₃ level decreases in such a manner that it remains below the maximum storable NH₃ limit value. As shown above, the maximum storable NH₃ value can also be used as a limit value in order to check to what extent the regulation and, in particular, a load changeover actually is functioning. For example, monitoring can be assured in this case by a sensor recording of a possible NH₃ slip.

It is claimed:

1. An internal combustion engine comprising: at least one SCR catalytic converter; and at least one condition monitor of SCR catalytic converter for its NH3 level, wherein the condition monitor is connected to at least one first and one second detecting module that determine the NH3 level in different manners.

2. The internal combustion engine according to claim 1, further comprising a correlation unit connected to the first and second detecting module.

3. The internal combustion engine according to claim 1, wherein a stored weighting function by means of which an NH3 slip can be at least partially compensated between different detections of the NH3 level.

4. The internal combustion engine according to claim 1, wherein at least one of the first and second detecting module includes a sensor that is capable of recording a value in relation to the NH3 level.

5. The internal combustion engine according to claim 1, wherein at least the first and/or the second detecting module includes an integration of a mass flow relative to a supplied and consumed NH3 mass flow and/or has one or more stored characteristic diagrams containing a dependence of an NOx conversion on a stored NH3 amount in SCR catalytic converter and/or a physical model of SCR catalytic converter that has kinetic approaches to a storage behavior and/or a characteristic diagram-based determination of a current NH3 level of SCR catalytic converter.

6. The internal combustion engine according to claim 1, wherein the condition monitor is coupled to a load check and/or an SCR temperature check, wherein an NH3 slip avoidance threshold is present, and if the threshold is exceeded, an operating mode changeover of the internal combustion engine is initiated.

7. The internal combustion engine according to claim 1, wherein the condition monitor is coupled to an NH3 level regulation.

8. A method for determining an NH3 level of an SCR catalytic converter for an internal combustion engine according to claim 1, said method comprising the steps of: determining a value relevant to a respective NH3 level by at least two different determination paths, and wherein the at least two different determination paths are correlated to deduce a resulting NH3 level.

9. The method according to claim 8, wherein a respective NH3 level is acquired by different determination paths, and wherein the different determination paths are correlated with one another in order to arrive at a resulting NH3 level.

10. The method according to claim 8, wherein a drift between at least two differently determined values is deduced from the results of different determination paths.

11. The method according to claim 8, wherein a diagnostic system can be created that uses different determination paths to check a subsystem for determining the NH3 level.

12. The method according to claim 8, wherein a threshold value is set for a beginning of an NH3 slip, and if the threshold is exceeded, the internal combustion engine changes its operating mode.

13. Application of at least one of the determination paths according to claim 8 for monitoring an SCR catalytic converter of an internal combustion engine.

14. An internal combustion engine comprising:
a SCR catalytic converter;
a condition monitor for monitoring a NH3 level of said SCR catalytic converter;
a first detecting module connected to said condition monitor; and
a second detecting module connected to said condition monitor;
wherein said first detecting module determines said NH3 level of said SCR catalytic converter in a first manner, and wherein said second detecting module determines said NH3 level of said catalytic converter in a second manner different from said first manner.
